(19) United States
(12) Patent Application Publication
(10) Pub. No.: US 2005/0127620 A1
(43) Pub. Date: Jun. 16, 2005

(54) Trailer with mechanically activated dolly legs

(76) Inventor: Robert Amundson, Amisk (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/003,609

(22) Filed: Dec. 3, 2004

(30) Foreign Application Priority Data
Dec. 12, 2003 (CA) 2,450,063

(51) Int. Cl. B60S 9/00

(52) U.S. Cl. 280/6.153

(57) ABSTRACT

A trailer with mechanically activated dolly legs includes a trailer body having a front towing end and a rear end. Ground engaging support wheels are positioned at the rear end. Means are provided for attachment to a tow vehicle at the front towing end. Dolly legs are positioned spaced from and underlying the front towing end. The dolly legs are housed in a housing and are movable relative to the housing between an extended position and a retracted position. At least one air bag is positioned between the dolly legs and the housing. The air bag is adapted to move the dolly legs from the retracted position to the extended position.

### FIELD OF THE INVENTION

The present invention relates to a trailer having dolly legs, which can be mechanically extended or retracted.

### BACKGROUND OF THE INVENTION

Large trailer units have underlying dolly legs positioned at their hitch end. These dolly legs are extended down to the ground to provide support, when the trailer is not attached to and supported by a tow vehicle. Most trailers dolly legs are presently extended and retracted by means of a mechanical crank mechanism.

### SUMMARY OF THE INVENTION

What is required is an alternative form of mechanically activated dolly legs.

According to the present invention there is provided a trailer with mechanically activated dolly legs, which includes a trailer body having a front towing end and a rear end. Ground engaging support wheels are positioned at the rear end. Means are provided for attachment to a tow vehicle at the front towing end. Dolly legs are positioned spaced from and underlying the front towing end. The dolly legs are housed in a housing and are movable relative to the housing between an extended position and a retracted position. At least one air bag is positioned between the dolly legs and the housing. The air bag is adapted to move the dolly legs from the retracted position to the extended position.

With the trailer, as described above, the dolly legs are air activated for movement from their retracted position to their extended position. Once the basic teachings of this invention are understood, there are additional features which may be added to further enhance performance.

Although beneficial results may be obtained through the use of the trailer, as described above, even more beneficial results may be obtained when a spring is provided in the housing which is adapted to exert a biasing force urging the dolly legs from the extended position back into the retracted position.

Although beneficial results may be obtained through the use of the trailer, as described above, when the trailer has an air suspension system with an air supply tank, even more beneficial results may be obtained by having air supplied to the air bag or air bags from the air supply tank.

Although beneficial results may be obtained through the use of the trailer, as described above, it would be undesirable for the dolly legs to retract due to a sudden or gradual loss of air pressure. Even more beneficial results may, therefore, be obtained when the dolly legs have apertures adapted to receive locking pins to maintain the dolly legs in the extended position, should a loss of air pressure occur.

Although beneficial results may be obtained through the use of the trailer, as described above, there are limits on the distance that the dolly legs can be moved using an air bag. If the distance exceeds the manufacturers specifications for the air bag, stability problems will be encountered. Even more beneficial results may, therefore, be obtained when the dolly legs have telescopic leg extensions. Each of the leg extensions have an upper end and a lower end. The lower end of each of the leg extensions terminates in a support foot. The upper end of each of the leg extensions extends telescopically into the dolly legs. Means are provided to fix the leg extensions in a selected telescopic position. In the illustrated embodiment, the leg extensions screw into the dolly legs, however, locking pins or other means could also be used. The leg extensions are initially set to accommodate the stroke of the air bag or air bags. They can be adjusted, as required. For example, when the trailer is parked with the dolly legs positioned over a hollow, the leg extensions can be extended. When travelling over uneven ground where additional clearance is desired, the leg extensions can be retracted.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a trailer with mechanically activated dolly legs constructed in accordance with the teachings of the present invention, with the dolly legs in the retracted position.

FIG. 2 is a detailed side elevation view, in section, of the trailer illustrated in FIG. 1, with the dolly legs in the extended position.

FIG. 3 is a side elevation view, in section, of an alternative embodiment of trailer with mechanically activated dolly legs constructed in accordance with the teachings of the present invention, with the dolly legs in the retracted position.

FIG. 4 is a detailed side elevation view, in section, of the dolly legs illustrated in FIG. 3.

### DETAILED DESCRIPTION OF THE PREFERRED EMBODIMENT

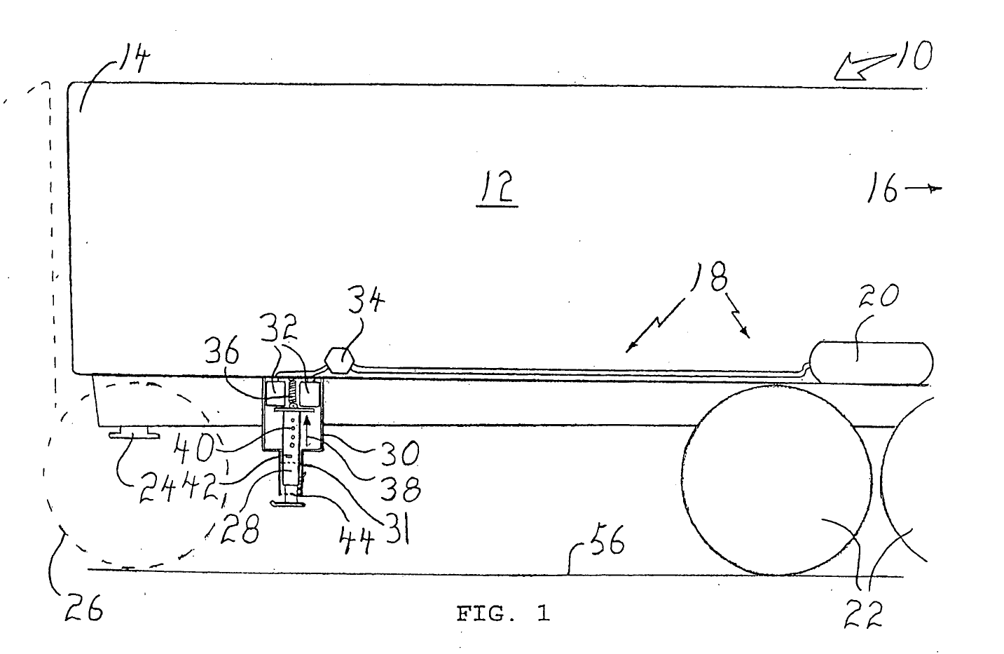

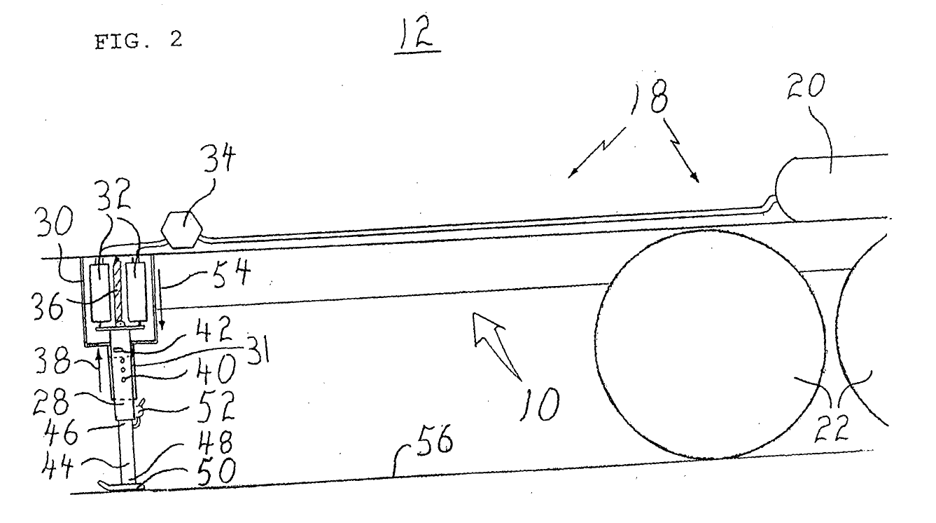

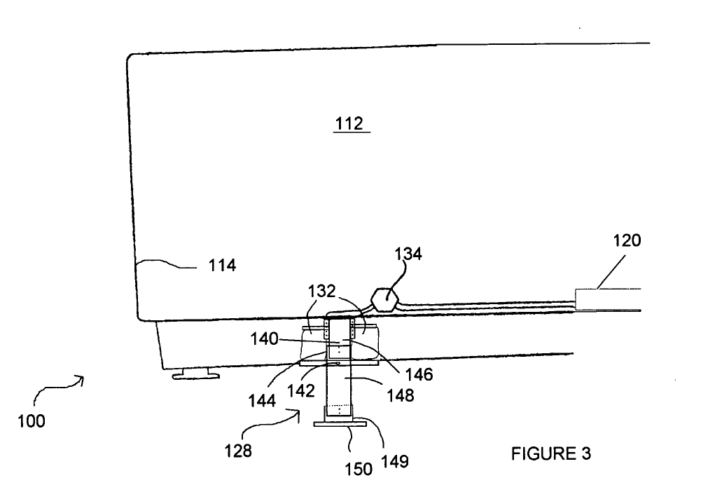

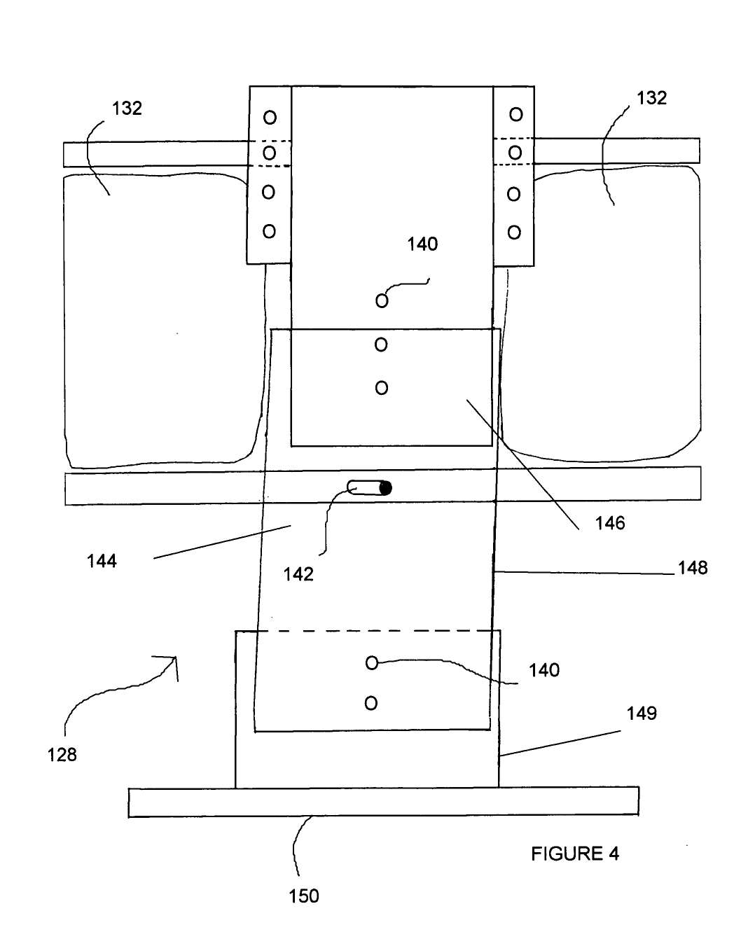

The preferred embodiment, a trailer generally identified by reference numeral 10, will now be described with reference to FIGS. 1 and 2. An alternative embodiment will be described with reference to FIGS. 3 and 4.

Structure and Relationship of Parts:

Referring to FIG. 1, trailer 10 has a trailer body 12 with a front towing end 14 and a rear end 16. Mounted on trailer body 12 is an air suspension system 18 supplied with air from an air supply tank 20. Body 12 is further adapted with ground engaging support wheels 22 at rear end 16 and a hitch 24 adapted for attachment to a tow vehicle 26 at front towing end 14. Dolly legs 28 (one profile is shown) are spaced from and underlie front towing end 14 of body 12. Dolly legs 28 are housed in a housing 30 which is attached to body 12. The housing may also have rigid depending sleeves 31 adapted to provide enhanced lateral stability to the dolly legs. Dolly legs 28 are movable relative to housing 30 between an extended position as illustrated in FIG. 2 and a retracted position as illustrated in FIG. 1. Referring to FIG. 2, in the illustrated embodiment, two air bags 32 are positioned between dolly legs 28 and housing 30. Air bags 32 are adapted to move dolly legs 28 from the retracted position to the extended position. Air is supplied to air bags 32 from air supply tank 20. A control valve 34 is provided to control the flow of air to air bags 32 and exhaust air from air bags 32. A spring 36 is positioned in housing 30. Spring 36 is adapted to exert a biasing force, (as indicated by arrows 38), urging dolly legs 28 from the extended position back into the retracted position. Dolly legs 28 have apertures 40 adapted to receive locking pins 42 to maintain dolly legs 28 in the extended position should air bags 32 experience a loss of air pressure. Dolly legs 28 are further adapted with telescopic leg extensions 44. Each of leg extensions 44 having an upper end 46 and a lower end 48. Each lower end 48 terminates in a support foot 50. Each upper end 46 extends telescopically into each dolly leg 28. In the illustrated embodiment, a latch 52 is provided to fix each leg extension 44 in a selected telescopic position.

Operation:

The use and operation of trailer with mechanically activated dolly legs will now be described with reference to FIGS. 1 and 2. Referring to FIG. 1, where trailer 10 is being towed by vehicle 26 and is in active operation, air bags 32 are deflated and spring 36 exerts a biasing force 38 to retract dolly legs 28 into housing 30. Leg extensions 44 are fixed at a desirable height for ground clearance and retract upwards along with dolly legs 28. Referring to FIG. 2, where trailer 10 is no longer attached to vehicle 26 and is in a resting mode, control valve 34 allows air from supply tank 20 into air bags 32 which exert a force (indicated by arrow 54) extending dolly legs 28 from housing 30 toward ground surface 56. Where a user desires to adjust the moment of contact of support foot 50 with ground surface 56, leg extensions 44 are telescopically extended from dolly legs 28 and fixed in place by latch 52. In order to guard against the accidental deflation of air bags 32, locking pins 42 are engaged with an appropriate one of apertures 40 to ensure safety and maintain trailer 10 in a stable position.

It will be appreciated that although FIG. 1 uses an air supply tank 20 as the air supply for the air suspension system 18, it will be understood that it would be possible to supply air from another source. For example, air could be supplied from an air supply tank on a tow vehicle.

Variations:

An alternative embodiment, a trailer generally identified by reference numeral 100, will now be described with reference to FIGS. 3 and 4. Referring to FIG. 3, with alternative embodiment 100, dolly legs, generally referenced by numeral 128 (one profile is shown) are spaced from and underlie front towing end 114 of body 112. Dolly legs 128 are movable relative to body 112 between an extended position as illustrated with respect to dolly legs 38 of embodiment 10 in FIG. 2 and a retracted position as illustrated in FIG. 1.

Referring to FIG. 3, in the illustrated embodiment, two air bags 132 are positioned between dolly legs 128 and body 112. Air bags 132 are adapted to move dolly legs 128 from the retracted position to the extended position. Air is supplied to air bags 132 from air supply tank 120. A control valve 134 is provided to control the flow of air to air bags 132 and exhaust air from air bags 132.

Referring to FIG. 4, dolly legs 128 have apertures 140 adapted to receive locking pin 142 to maintain dolly legs 128 in the extended position should air bags 132 experience a loss of air pressure. With embodiment 100, dolly legs 128 are further adapted with telescopic leg extensions 144. A first section 146 of telescopic leg extensions 144 is fixed to body 112. A second section 148 is received within first telescopic leg extensions 144. Second section 148 extends into a third section 149 which terminates in a support foot 150. A second section 148 is telescopically movable within first section. The position of second section 148 within first section 146 can maintained by to inserting locking pin 142 into one of the apertures 140 on first section 146. Likewise, second section 148 can also move telescopically within third section 149. The position of second section 148 within third section 149 can maintained inserting locking pin 142 into one of the apertures 140 on third section 146.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. A trailer with mechanically activated dolly legs, comprising:
a trailer body having a front towing end and a rear end;
ground engaging support wheels at the rear end;
means for attachment to a tow vehicle at the front towing end;
dolly legs spaced from and underlying the front towing end, the dolly legs being housed in a housing and being movable relative to the housing between an extended position and a retracted position; and
at least one air bag positioned between the dolly legs and the housing, which is adapted to move the dolly legs from the retracted position to the extended position.

2. The trailer as defined in claim 1, wherein a spring is provided in the housing which is adapted to exert a biasing force urging the dolly legs from the extended position back into the retracted position.

3. The trailer as defined in claim 1, wherein the trailer has an air suspension system with an air supply tank, air being supplied to the at least one air bag from the air supply tank.

4. The trailer as defined in claim 1, wherein the dolly legs have apertures adapted to receive locking pins to maintain the dolly legs in the extended position.

5. The trailer as defined in claim 1, wherein the dolly legs have telescopic leg extensions, each of the leg extensions having an upper end and a lower end, the lower end of the leg extensions terminating in a support foot, the upper end of the leg extensions extending telescopically into the dolly legs, means being provided to fix the leg extensions in a selected telescopic position.

6. The trailer as defined in claim 1, wherein the housing has depending sleeves adapted to provide lateral stability to the dolly legs.

7. A trailer with mechanically activated dolly legs, comprising:
a trailer body having a front towing end, a rear end and an air suspension system with an air supply tank;
ground engaging support wheels at the rear end;
a hitch adapted for attachment to a tow vehicle at the front towing end;
dolly legs spaced from and underlying the front towing end, the dolly legs being housed in a housing and being movable relative to the housing between an extended position and a retracted position, the housing having depending sleeves which are adapted to enhance lateral stability of the dolly legs;
at least one air bag positioned between the dolly legs and the housing, which is adapted to move the dolly legs from the retracted position to the extended position, air being supplied to the at least one air bag from the air supply tank with a control valve being provided to control the flow of air to and from the at least one air bag;
a spring positioned in the housing, which is adapted to exert a biasing force urging the dolly legs from the extended position back into the retracted position;
the dolly legs having apertures adapted to receive locking pins to maintain the dolly legs in the extended position should the at least one air bag experience a loss of air pressure;
the dolly legs having telescopic leg extensions, each of the leg extensions having an upper end and a lower end, the lower end of the leg extensions terminating in a support foot, the upper end of the leg extensions extending telescopically into the dolly legs, means being provided to fix the leg extensions in a selected telescopic position.
